(19) United States
(12) Patent Application Publication
(10) Pub. No.: US 2004/0130546 A1
(43) Pub. Date: Jul. 8, 2004

(54) Region growing with adaptive thresholds and distance function parameters

(76) Inventor: Fatih M. Porikli, North Plainfield, NJ (US)

Correspondence Address: Patent Department, Mitsubishi Electric Research Laboratories, Inc., 201 Broadway, Cambridge, MA, 02139, US

(21) Appl. No.: 10/336,976

(22) Filed: Jan. 6, 2003

(51) Int. Cl. G06T 15/30

(52) U.S. Cl. 345/423

(57) ABSTRACT

A method segments colored pixels in an image. First, global features are extracted from the image. Then, the following steps are repeated until all pixels have been segmented from the image. A set of seed pixels is selected in the image based on gradient magnitudes of the pixels. Local features are defined for the set of seed pixels. Parameters and thresholds of a distance function are defined from the global and local features. A region is grown around the seed pixels according to the distance function, and the region is segmented from the image.

### FIELD OF THE INVENTION

The present invention relates generally to segmenting images, and more particularly to segment images by growing regions of pixels.

### BACKGROUND OF THE INVENTION

Region growing is one of a most fundamental and well known method for image and video segmentation. A number of region growing techniques are known in the prior art, for example, setting color distance thresholds, Taylor et al., “Color Image Segmentation Using Boundary Relaxation,” ICPR, Vol.3, pp. 721-724, 1992, iteratively relaxing thresholds, Meyer, “Color image segmentation,” ICIP, pp. 303-304, 1992, navigation into higher dimensions to solve a distance metric formulation with user set thresholds, Priese et al., “A fast hybrid color segmentation method,” DAGM, pp. 297-304, 1993, hierarchical connected components analysis with predetermined color distance thresholds, Westman et al., “Color Segmentation by Hierarchical Connected Components Analysis with Image Enhancements,” ICPR, Vol.1, pp. 796-802, 1990.

In region growing methods for image segmentation, adjacent pixels in an image that satisfy some neighborhood constraint are merged when attributes of the pixels, such as color and texture, are similar enough. Similarity can be established by applying a local or global homogeneity criterion. Usually, a homogeneity criterion is implemented in terms of a distance function and corresponding thresholds. It is the formulation of the distance function and its thresholds that has the most significant effect on the segmentation results.

Most methods either use a single predetermined threshold for all images, or specific thresholds for specific images and specific parts of images. Threshold adaptation can involve a considerable amount of processing, user interaction, and context information.

MPEG-7 standardizes descriptions of various types of multimedia information, i.e., content, see ISO/IEC JTC1/SC29/WG11 N4031, “Coding of Moving Pictures and Audio,” March 2001. The descriptions are associated with the content to enable efficient indexing and searching for content that is of interest to users.

The elements of the content can include images, graphics, 3D models, audio, speech, video, and information about how these elements are combined in a multimedia presentation. One of the MPEG-7 descriptors characterizes color attributes of an image, see Manjunath et al., “Color and Texture Descriptors,” IEEE Transactions on Circuits and Systems for Video Technology, Vol. 11, No. 6, June 2001.

Among several color descriptors defined in the MPEG-7 standard, a dominant color descriptor is most suitable for representing local object or image region features where a small number of colors are enough to characterize the color information in the region of interest. Whole images are also applicable, for example, flag images or color trademark images.

A set of dominant colors in a region of interest in an image provides a compact description of the image that is easy to index and retrieve. A dominant color descriptor depicts part or all of an image using a small number of colors. For example, in an image of a person dressed in a blueish shirt and reddish pants, blue and red are the dominant colors, and the dominant color descriptor includes not only these colors, but also a level of accuracy in depicting these colors within a given area.

To determine the color descriptor, colors in the image are first clustered. This results in a small number of colors. Percentages of the clustered colors are then measured. As an option, variances of dominant colors can also be determined. A spatial coherency value can be used to differentiate between cohesive and disperse colors in the image. A difference between a dominant color descriptor and a color histogram is that with a descriptor the representative colors are determined from each image instead of being fixed in the color space for the histogram. Thus, the color descriptor is accurate as well as compact.

By successive divisions of color clusters with a generalized Lloyd process, the dominant colors can be determined. The Lloyd process measures distances of color vectors to cluster centers, and groups the color vectors in cluster that have the smallest distance, see Sabin, “Global convergence and empirical consistency of the generalized Lloyd algorithm,” Ph.D. thesis, Stanford University, 1984.

Clustering, histograms, and the MPEG-7 standard are now described in greater detail.

Clustering

Clustering is an unsupervised classification of patterns, e.g., observations, data items, or feature vectors, into clusters. Typical pattern clustering activity involves the steps of pattern representation. Optionaly, clustering activity can also include feature extraction and selection, definition of a pattern proximity measure appropriate to the data domain (similarity determination), clustering or grouping, data abstraction if needed, and assessment of output if needed, see Jain et al., “Data clustering: a review,” ACM Computing Surveys, 31:264-323, 1999.

The most challenging step in clustering is feature extraction or pattern representation. Pattern representation refers to the number of classes, the number of available patterns, and the number, type, and scale of the features available to the clustering process. Some of this information may not be controllable by the user.

Feature selection is the process of identifying a most effective set of the image features to use in clustering. Feature extraction is the use of one or more transformations of input features to produce salient output features. Either or both of these techniques can be used to obtain an appropriate set of features to use in clustering. In small size data sets, pattern representations can be based on previous observations. However, in the case of large data sets, it is difficult for the user to keep track of the importance of each feature in clustering. A solution is to make as many measurements on the patterns as possible and use all measurements in the pattern representation.

However, it is not possible to use a large collection of measurements directly in clustering because of the amount of iterative processing. Therefore, several feature extraction and selection approaches have been designed to obtain linear or non-linear combinations of these measurements so that the measurements can be used to represent patterns.

The second step in clustering is similarity determination. Pattern proximities are usually measured by a distance function defined on pairs of patterns. A variety of distance measures are known. A simple Euclidean distance measure can often be used to reflect similarity between two patterns, whereas other similarity measures can be used to characterize a “conceptual” similarity between patterns. Other techniques use either implicit or explicit knowledge. Most of the knowledge-based clustering processes use explicit knowledge in similarity determinations.

However, if improper features represent patterns, it is not possible to get a meaningful partition, irrespective of the quality and quantity of knowledge used in similarity computation. There is no universally acceptable scheme for determining similarity between patterns represented using a mixture of both qualitative and quantitative features.

The next step in clustering is grouping. Broadly, there are two grouping schemes: hierarchical and partitional. The hierarchical schemes are more versatile, and the partitional schemes are less complex. The partitional schemes maximize a squared error criterion function. Because it is difficult to find an optimal solution, a large number of schemes are used to obtain a global optimal solution to this problem. However, these schemes are computationally prohibitive when applied to large data sets. The grouping step can be performed in a number of ways. The output of the clustering can be precise when the data are partitioned into groups, or fuzzy where each pattern has a variable degree of membership in each of the output clusters. Hierarchical clustering produces a nested series of partitions based on a similarity criterion for merging or splitting clusters.

Partitional clustering identifies the partition that optimizes a clustering criterion. Additional techniques for the grouping operation include probabilistic and graph-theoretic clustering methods. In some applications, it may be useful to have a clustering that is not a partition. This means clusters overlap.

Fuzzy clustering is ideally suited for this purpose. Also, fuzzy clustering can handle mixed data types. However, it is difficult to obtain exact membership values with fuzzy clustering. A general approach may not work because of the subjective nature of clustering, and it is required to represent clusters obtained in a suitable form to help the decision maker.

Knowledge-based clustering schemes generate intuitively appealing descriptions of clusters. They can be used even when the patterns are represented using a combination of qualitative and quantitative features, provided that knowledge linking a concept and the mixed features are available. However, implementations of the knowledge-based clustering schemes are computationally expensive and are not suitable for grouping large data sets. The well known k-means process, and its neural implementation, the Kohonen net, are most successful when used on large data sets. This is because the k-means process is simple to implement and computationally attractive because of its linear time complexity. However, it is not feasible to use even this linear time process on large data sets.

Incremental processes can be used to cluster large data sets. But those tend to be order-dependent. Divide and conquer is a heuristic that has been rightly exploited to reduce computational costs. However, it should be judiciously used in clustering to achieve meaningful results.

Vector Clustering

The generalized Lloyd process is a clustering technique, which is an extension of the scalar case for the case of having vectors, see Lloyd, “Least squares quantization in PCM,” IEEE Transactions on Information Theory, (28): 127-135, 1982. That method includes a number of iterations, each iteration recomputing a set of more appropriate partitions of the input states, and their centroids.

The process takes as input a set X={xₘ: i=1, . . . , M} of M input states, and generates as output a set C of N partitions represented with their corresponding centroids cₙ: n=1, . . . , N.

The process begins with an initial partition C₁, and the following steps are iterated:

(a) Given a partition representing a set of clusters defined by their centroids C_{K}={cₙ: i=1, . . . , N}, compute two new centroids for each centroid in the set C_{K} by pertubing the centroids, obtain a new partition set C_{K+1};

(b) Redistribute each training state into one of the clusters in C_{K+1} by selecting the one whose centroid is closer to each state;

(c) Recompute the centroids for each generated cluster using the centroid definition to obtain a new codebook C_{K+1};

(d) If an empty cell was generated in the previous step, an alternative code vector assignment is made, instead of the centroid computation; and

(e) Compute an average distortion D_{K+1} for C_{K+1}, until the rate of change of the distortion is less than some minimal threshold ε since the last iteration.

The first problem to solve is how to choose an initial codebook. The most common ways of generating the codebook are heuristically, randomly, by selecting input vectors from the training sequence, or by using a split process.

A second decision to be made is how to specify a termination condition. Usually, an average distortion is determined and compared to a threshold as follows:

$$\frac{\vert {D}_{K} - {D}_{K + 1} \vert}{{D}_{K}} < ϵ ,$$

where 0≦ε≦1.

There are different solutions for the empty cell problem that are related to the problem of selecting the initial codebook. One solution splits other partitions, and reassigning the new partition to the empty partition.

Dominant Color

To compute the dominant colors of an image, the vector clustering procedure is applied. First, all color vectors I(p) of an image I are assumed to be in the same cluster C_{1,} i.e., there is a single clusters. Here, p is an image pixel, and I(p) is a vector representing the color values of the pixel p. The color vectors are grouped into the closest cluster center. For each cluster Cₙ, a color cluster centroid cₙ is determined by averaging the values of color vectors that belong to that cluster.

A distortion score is computed for all clusters according to

$${D}_{K} = {\sum }_{n}^{N} {\sum }_{I ( p ) ∈ {C}_{n}} v ( p ) {‖ I ( p ) - {c}_{n} ‖}^{2} ,$$

where Cₙ is a centroid of cluster, and v(p) is a perceptual weight for pixel p. The perceptual weights are calculated from local pixel statistics to account for the fact that human vision perception is more sensitive to changes in smooth regions than in textured regions. The distortion score is a sum of the distances of the color vectors to their cluster centers. The distortion score measures the number of color vectors that changed their clusters after the current iteration. The iterative grouping is repeated until the distortion difference becomes negligible. Then, each color cluster is divided into two new cluster centers by perturbing the center when the total number of clusters is less than a maximum cluster number. Finally, the clusters that have similar color centers are grouped to determine a final number of the dominant colors.

Histograms

An important digital image tool is an intensity or color histogram. The histogram is a statistical representation of pixel data in an image. The histogram indicates the distribution of the image data values. The histogram shows how many pixels there are for each color value. For a single channel image, the histogram corresponds to a bar graph where each entry on the horizontal axis is one of the possible color values that a pixel can have. The vertical scale indicates the number of pixels of that color value. The sum of all vertical bars is equal to the total number of pixels in the image.

A histogram, h, is a vector [h[0], . . . , h[M]] of bins where each bin h[m] stores the number of pixels corresponding to the color range of m in the image I, where M is the total number of the bins. In other words, the histogram is a mapping from the set of color vectors to the set of positive real numbers R⁺. The partitioning of the color mapping space can be regular with bins of identical size. Alternatively, the partitioning can be irregular when the target distribution properties are known. Generally, it is assumed that h[m] are identical and the histogram is normalized such that

$${\sum }_{m = 0}^{M} h [ m ] = 1.$$

The cumulative histogram H is a variation of the histogram such that

$$H [ u ] = {\sum }_{m = 0}^{u} h [ m ] .$$

This yields the counts for all the bins smaller than u. In a way, it corresponds a probability function, assuming the histogram itself is a probability density function. A histogram represents the frequency of occurrence of color values, and can be considered as the probability density function of the color distribution. Histograms only record the overall intensity composition of images. The histogram process results in a certain loss of information and drastically simplify the image.

An important class of pixel operations is based upon the manipulation of the image histogram. Using histograms, it is possible to enhance the contrast of an image, to equalize color distribution, and to determine an overall brightness of the image.

Contrast Enhancement

In contrast enhancement, the intensity values of an image are modified to make full use of the available dynamic range of intensity values. If the intensity of the image extends from 0 to 2^{B}−1, i.e., B-bits coded, then contrast enhancement maps the minimum intensity value of the image to the value 0, and the maximum to the value to 2^{B}−1. The transformation that converts a pixel intensity value I(p) of a given pixel to the contrast enhanced intensity value I*(p) is given by:

$$I * ( p ) = ( {2}^{B} - 1 ) \frac{I ( p ) - min}{max - min} .$$

However, this formulation can be sensitive to outliers and image noise. A less sensitive and more general version of the transformation is given by:

$${I}_{2} ( p ) = \{ \begin{matrix}0 & {I}_{1} ( p ) < low \\ ( {2}^{B} - 1 ) \frac{{I}_{1} ( p ) - low}{high - low} & low \leq {I}_{1} ( p ) < high \\ ( {2}^{B} - 1 ) & high \leq {I}_{1} ( p )\end{matrix} .$$

In this version of the formulation, one might select the 1% and 99% values for low and high, respectively, instead of the 0% and 100% values representing min and max in the first version. It is also possible to apply the contrast enhancement operation on a regional basis using the histogram from a region to determine the appropriate limits for the algorithm.

When two images need to be compared on a specific basis, it is common to first normalize their histograms to a “standard” histogram. A histogram normalization technique is histogram equalization. There, the histogram h[m] is changed with a function g[m]=ƒ(h[m]) into a histogram g[m] that is constant for all color values. This corresponds to a color distribution where all values are equally probable. For an arbitrary image, one can only approximate this result.

For an equalization function ƒ(.), the relation between the input probability density function, the output probability density function, and the function ƒ(.) is given by:

$${p}_{g} ( g ) \partial g = {p}_{h} ( h ) \partial h ⇒ \partial f = \frac{{p}_{h} ( h ) \partial h}{{p}_{g} ( g )} .$$

From the above relation, it can be seen that ƒ(.) is differentiable, and that ∂ƒ/∂h≧0. For histogram equalization, p_{g}(g)=constant. This implies:

ƒ(h[m])=(2^{B}−1)H[m],

where H[m] is the cumulative probability function. In other words, the probability distribution function normalized from 0 to 2^{B}−1.

MPEG-7

The MPEG-7 standard, formally named “Multimedia Content Description Interface”, provides a rich set of standardized tools to describe multimedia content. The tools are the metadata elements and their structure and relationships. These are defined by the standard in the form of Descriptors and Description Schemes. The tools are used to generate descriptions, i.e., a set of instantiated Description Schemes and their corresponding Descriptors. These enable applications, such as searching, filtering and browsing, to effectively and efficiently access multimedia content.

Because the descriptive features must be meaningful in the context of the application, they are different for different user domains and different applications. This implies that the same material can be described using different types of features, adapted to the area of application. A low level of abstraction for visual data can be a description of shape, size, texture, color, movement and position. For audio data, a low abstraction level is musical key, mood, and tempo. A high level of abstraction gives semantic information, e.g., ‘this is a scene with a barking brown dog on the left and a blue ball that falls down on the right, with the sound of passing cars in the background.’ Intermediate levels of abstraction may also exist.

The level of abstraction is related to the way the features can be extracted: many low-level features can be extracted in fully automatic ways, whereas high level features need more human interaction.

Next to having a description of what is depicted in the content, it is also required to include other types of information about the multimedia data. The form is the coding format used, e.g., JPEG, MPEG-2, or the overall data size. This information helps determining how content is output. Conditions for accessing the content can include links to a registry with intellectual property rights information, and price. Classification can rate the content into a number of pre-defined categories. Links to other relevant material can assist searching. For non-fictional content, the context reveals the circumstances of the occasion of the recording.

Therefore, MPEG-7 Description Tools enable the creation of descriptions as a set of instantiated Description Schemes and their corresponding Descriptors including: information describing the creation and production processes of the content, e.g., director, title, short feature movie; information related to the usage of the content. e.g., copyright pointers, usage history, broadcast schedule; information of the storage features of the content, e.g., storage format, encoding; structural information on spatial, temporal or spatio-temporal components of the content, e.g., scene cuts, segmentation in regions, region motion tracking; information about low level features in the content, e.g., colors, textures, sound timbres, melody description; conceptual information of the reality captured by the content, e.g., objects and events, interactions among objects; information about how to browse the content in an efficient way, e.g., summaries, variations, spatial and frequency subbands; information about collections of objects; and information about the interaction of the user with the content, e.g., user preferences, usage history. All these descriptions are of course coded in an efficient way for searching, filtering, and browsing.

Region-Growing

A region of points is grown iteratively by grouping neighboring points having similar characteristics. In principle, region-growing methods are applicable whenever a distance measure and linkage strategy can be defined. Several linkage methods of region growing are known. They are distinguished by the spatial relation of the points for which the distance measure is determined.

In single-linkage growing, a point is joined to neighboring points with similar characteristics.

In centroid-linkage growing, a point is joined to a region by evaluating the distance between the centroid of the target region and the current point.

In hybrid-linkage growing, similarity among the points is based on the properties within a small neighborhood of the point itself, instead using only the immediate neighbors.

Another approach considers not only a point that is in the desired region, but also counter example points that are not in the region.

These linkage methods usually start with a single seed point p and expand from that seed point to fill a coherent region.

It is desired to combine these known techniques, along with newly developed techniques, in a novel way to adaptively grow regions in images. In other words, it is desired to adaptively determine threshold and distance functions parameters that can be applied to any image or video.

### SUMMARY OF THE INVENTION

The present invention provides a threshold adaptation method for region based image and video segmentation that takes the advantage of color histograms and MPEG-7 dominant color descriptor. The method enables adaptive assignment of region growing parameters.

Three parameter assignment techniques are provided: parameter assignment by color histograms; parameter assignment by vector clustering; and parameter assignment by MPEG-7 dominant color descriptor.

An image is segmented into regions using centroid-linkage region growing. The aim of the centroid-linkage process is to generate homogeneous regions. Homogeneity is defined as the quality of being uniform in color composition, i.e., the amount of color variation. This definition can be extended to include texture and other features as well.

A color histogram of the image approximates a color density function. The modality of this density function refers to the number of its principal components. For a mixture of models representation, the number of separate models determine the region growing parameters. A high modality indicates a larger number of distinct color clusters of the density function. Points of a color homogeneous region are more likely to be in the same color cluster, rather than being in different clusters. Thus, the number of clusters is correlated with the homogeneity specifications of regions. The color cluster that a region corresponds determines the specifications of homogeneity for that region.

The invention computes parameters of the color distance function and its thresholds that may differ for each region. The invention provides an adaptive region growing method, and results show that the threshold assignment method is faster and is more robust than prior art techniques.

### BRIEF DESCRIPTION OF THE DRAWINGS

FIG. 1 is a block diagram of pixels to be grown into a region;

FIG. 2 is a block diagram of pixels to be included;

FIG. 3 is a block diagram of a coherent region;

FIG. 4 is a flow diagram of region growing and segmentation according to the invention;

FIG. 5 is a flow diagram of centroid-linkage region growing;

FIG. 6 is a flow diagram of adaptive parameter selection using color vector clustering;

FIG. 7 is flow diagram for determining cluster centers;

FIGS. 8A and 8B are flow diagrams of channel projection;

FIG. 9 is a flow diagram for determining inter-maxima distances;

FIG. 10 is a flow diagram for determining parameters of color distances;

FIG. 11 is a flow diagram of color distance formulation;

FIG. 12 is a flow diagram for an adaptive parameter selection using color histograms;

FIGS. 13A and 13B illustrate color histogram construction;

FIGS. 14A and 14B illustrate histogram smoothing;

FIGS. 15A and 15B illustrate locating local maxima;

FIGS. 16A and 16B illustrate histogram distance formulation;

FIG. 17 is a flow diagram for an adaptive region growing using MPEG-7 descriptors; and

FIGS. 18A and 18B are flow diagrams of channel projection using MPEG-7 descriptors.

### DETAILED DESCRIPTION OF THE PREFERRED EMBODIMENTS

Centroid-Linkage Method

The invention provides a method for growing regions of similar pixels in an image. The method can also be applied to a sequence of images, i.e., video, to grow a volume. Region growing can be used for segmenting an object from the image or the video. In principle, region growing method can be used whenever a distance measure and a linkage strategy are defined. Described are several linkage methods that distinguish a spatial relation of the pixels for which the distance measure are determined.

The centroid-linkage method prevents region “leakage” when the intensity of the image varies smoothly, and strong edges, that could encircle regions, are missing. The centroid-linkage method can construct a homogeneous region when detectable edge boundaries are missing, although this property sometimes causes segmentation of a smooth region with respect to initial parameters. A norm of the distance measure reflects significant intensity changes into the distance magnitude, and suppresses small variances.

One centroid statistic is to keep a mean of pixels color values in the region. As each new pixel is added, the mean is updated. Although gradual drift is possible, the weight of all previous pixels in the region acts as a damper on such drift.

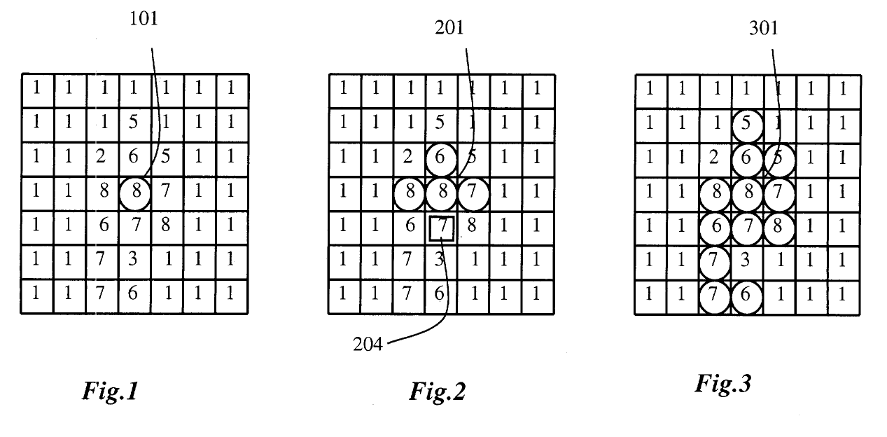

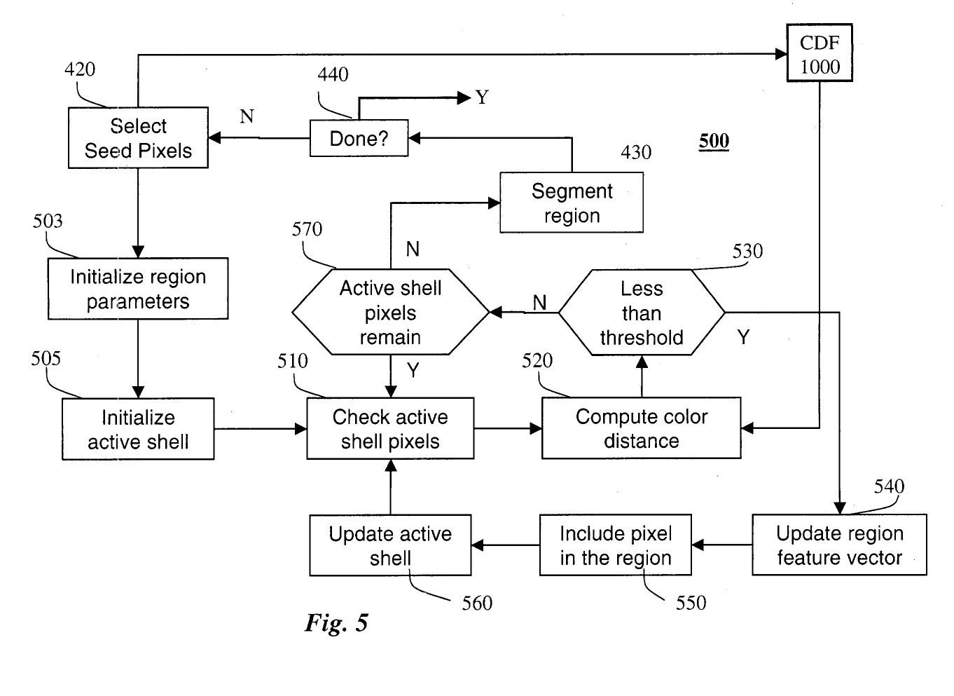

As shown in FIGS. 1-3, region growing begins with a single seed pixel p 101 that is expanded to fill a coherent region s 301, see FIG. 3. The example seed pixel 101 has an arbitrary value of “8,” and a distance threshold is set arbitrarily to “3.” In the centroid-linkage method according to the invention a candidate pixel 204 is compared with a centroid value 202. Each pixel, e.g., pixel 204, on the boundary of the current region 201 is compared with a centroid value. If the distance is less than the threshold, then the neighbor pixel 204 is included in the region, and the centroid value is updated. The inclusion process continues until no more boundary pixel can be included in the region. Note that centroid-linkage does not cause region leakages unlike the single-linkage method, which only measures pixel-wise distances.

Similarity Evaluation

A distance function for measuring a distance between a pixel p and a pixel q is defined as Ψ(p, q), such that the distance function produces a low value when pixels p and q are similar, and a high value otherwise. Consider that the pixel p is adjacent to the pixel q. The pixel q can then be in a region s of the pixel p when Ψ(p, q) is less than some threshold ε. Then, another pixel adjacent to pixel q can be considered for inclusion in region s, and so forth.

The invention provides for a way to define the distance function Ψ, including its parameters, and a threshold ε, and some means for updating attributes of the region. Note that the threshold is not limited to a constant number. It can be a function of image parameters, pixel color values, and other prior information.

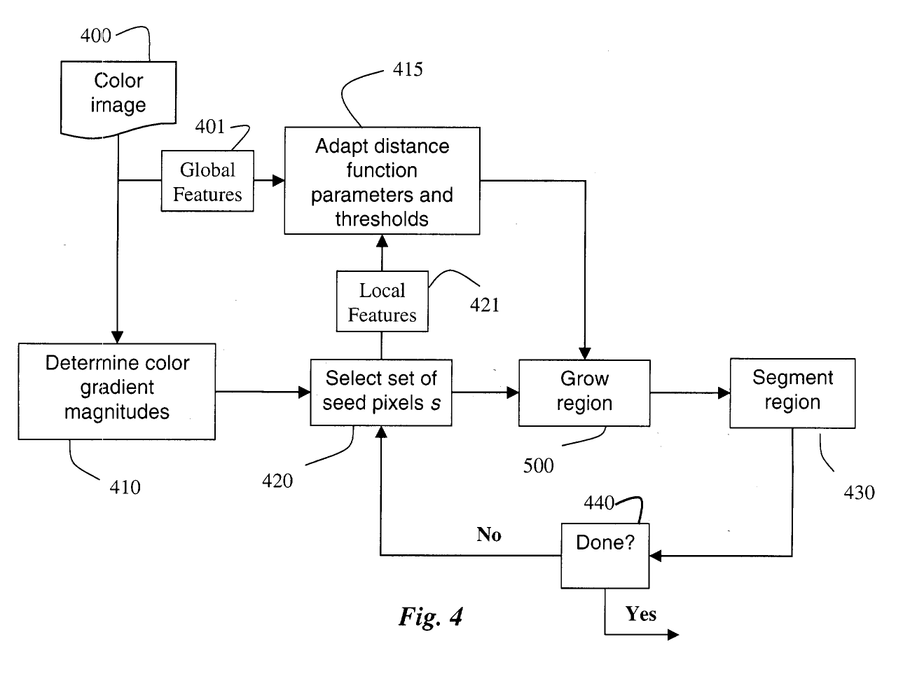

One distance function compares color values of individual pixels. In centroid-linkage, each pixel p is compared to a region-wise centroid c by evaluating a distance function Ψ(c, p) between the centroid of the target region 201 and the pixel as shown in FIG. 2. Here, the centroid value of the current “coherent” region is 7.2.

The threshold ε for the distance function Ψ determines the homogeneity of the region. Small threshold values tend to generate multiple small regions with consistent colors and cause over-segmentation. On the other hand, larger threshold values can combine regions that have different colors. Large threshold values are insensitive to the edges and results in under-segmentation. Thus, the distance threshold controls the color variance of the region. The dynamic range of the color has also similar effect.

Initially, the region s only includes the selected seed pixel 101. Alternatively, the region can be initialized with a small set of seed pixels to better describe the statistics of the region. With such an initialization, the region mean and variance are both updated. Candidate pixels can be compared to the region mean according to the region's variance. The variance can be determined by sampling a small area around the seed pixel.

Adaptive Region Growing and Segmentation Method

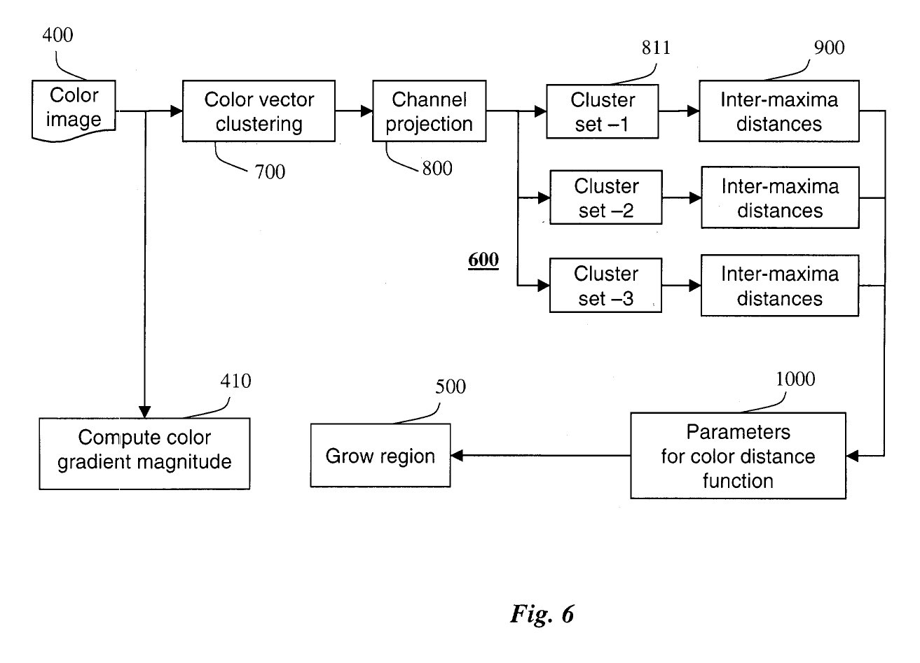

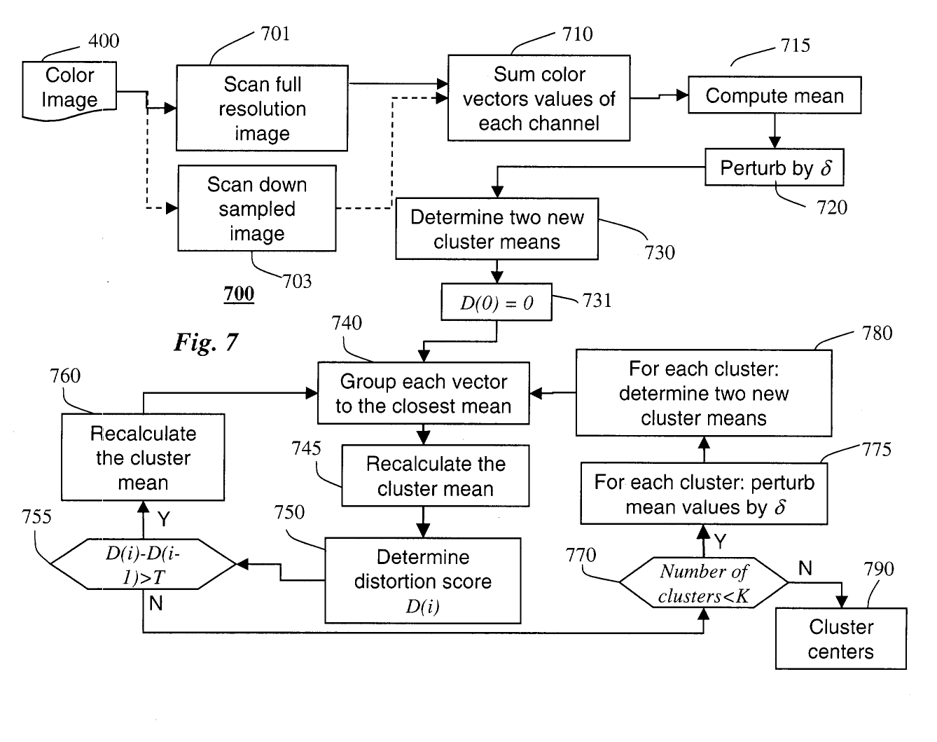

The steps of the adaptive region growing and segmentation according to the invention are shown in FIG. 4. The details of the centroid-linkage region growing 500 are given in FIG. 5.

From an input image 400, global features 401 are extracted. In addition, color gradient magnitudes are determined 410. Using a minimum color gradient magnitude, a set of seed pixels s is selected 420.

Local features 421 are defined for the set of seed pixels. The features can be determined by color vector clustering, by histogram modalities, or by MPEG-7 dominant color descriptors, as described in detail below. The global features of the entire image, and the local features for this set of seed pixels are used to define 415 parameters and thresholds of an adaptive distance function Ψ.

A region is grown 500 around the set of seed pixels with respect to the adapted distance function. The region is segmented 430 according to the grown region, and the process repeats for the next minimum color gradient magnitude, until all pixels in the image have been segmented, and the method completes 440.

The set of seed pixels s is selected 420 so that the set s best characterizes pixels in a local neighborhood. The set can be a single seed pixel. Good candidate seed pixels have a small color gradient magnitude. Thus, the color gradient magnitude |∇I(p)| is measured 410 for each pixel in an image 400. The color gradient magnitude is computed using the color difference between spatially opposite neighbors p⁻ and p⁺ of a current pixel.

|∇I(p)|=|I(p⁻)−I(p⁺)|ₓ+|I(p⁻)−I(p⁺)|_{y}.

The magnitudes of the differences along the x and y-axes are added to determine the total gradient magnitude. Other metrics, e.g., Euclidean distance can also be used. For each axis, the color difference is computed as the sum of the separate color channel differences. Again magnitude distance norm, Euclidean norm, or any other distance metric can be used to measure these differences such as |I(p⁻)−I(p⁺)|≡|I_{R}(p⁻)−I_{R}(p⁺)|+|I_{G}(p⁻)−I_{G}(p⁺)|+|I_{B}(p⁻)−I_{B}(p⁺)|

or |I(p⁻)−I(p⁺)|≡\sqrt{[I_{R}(p⁻)−I_{R}(p⁺)]²+[I_{G}(p⁻)−I_{G}(p⁺)]²+[I_{B}(p⁻)−I_{B}(p⁺)]²}.

The set of seed pixels is selected 420 according to

$${s}_{i} = {arg min}_{Q} \vert ∇ I ( p ) \vert ; Q = S - {{⋃}_{j = 1}}^{i} {R}_{j} ,$$

where Q is initially the set of all pixels in the image. After the region is grown 500 around the set of seed pixels, the regions is segmented 430, and the process repeats for the remaining pixels, until no pixel remain.

For computational simplicity, the gradients and seed selection can be carried out on a down-sampled image.

As shown in FIG. 5, region growing 500 proceeds as follows. The set of seed pixel selected 420 and a region to be grown is initialized 503 by assigning the color value of the seed pixels as the region centroid c=I(s) as

c: [c_{R}, c_{G}, c_{B}]=[I_{R}(s), I_{G}(s), I_{B}(s)].

Above, [c_{R}, c_{R}, c_{R}] and [I_{R}(s), I_{G}(s), I_{B}(s)] are the values of the centroid vector and the seed pixels respectively, i.e., the red, green, blue color values. The seed pixels are included 505 in an active shell set. For each pixel in the active shell set, the neighboring pixels are checked 510, and color distances are computed 520 by evaluating the color distance function (CDF) 1000. In step 530, determine if the distance is less than an adaptive threshold. Then, a region feature vector is updated 540 according to

$${c}_{m + 1} = \frac{M {c}_{m} + I ( p )}{M + 1} ,$$

where M is the number of pixels already included in the region before the current pixel p, and cₘ, cₘ₊₁ are the region centroid vectors before and after including the pixel p. The above equation implies

$${c}_{R , m + 1} = \frac{M {c}_{R , m} + {I}_{R} ( p )}{M + 1}$$

for an element of the centroid vector, e.g., for the red color channel. Other region statistics, such as the variance, moments, etc. are updated similarly. The pixel is included 550 in the region, and new neighbors are determined and the active shell set is updated 560. Otherwise, determine 570 if there are any remaining active shell pixels. The neighborhood can be selected 4-pixels, 8-pixels, or any other local spatial neighborhood. The remaining active shell pixels are evaluated in the next iteration 510, until no more new active pixel remains 570, and region is segmented 430 until the whole image is done 440.

Adaptive Parameter Assignment with Color Vector Clustering

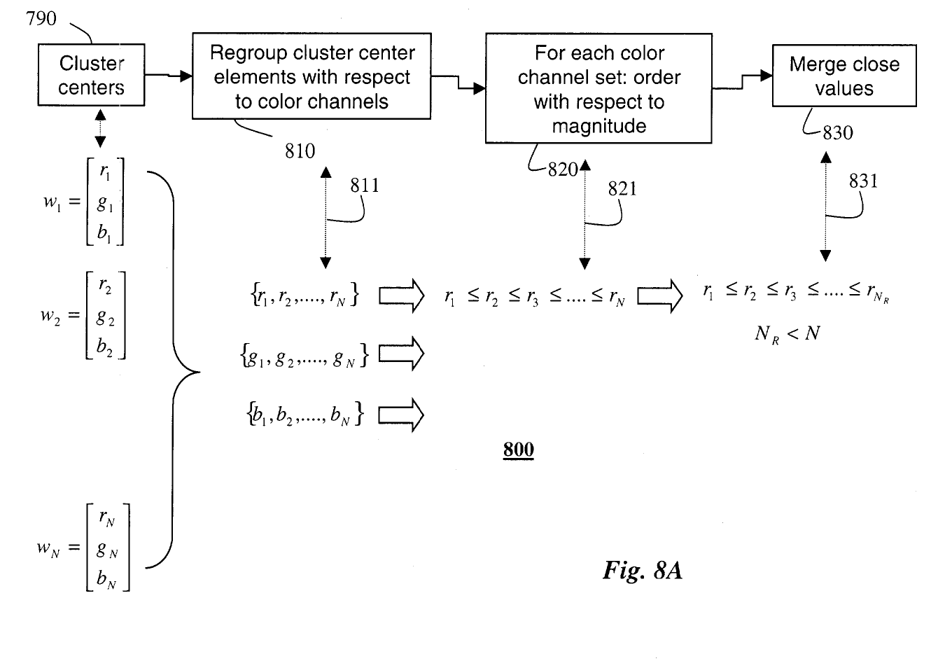

The details of adaptive parameter assignment with color vector clustering are now described in greater detail, first with reference to FIG. 6.

The result of color vector clustering 700 is regrouped 800 using channel projection with respect to color channels 811. For each color channel, some inter-maxima distances 900 are determined. These distances are used to determine parameters for the color distance function 1000 and a threshold ε. The color distance function and the threshold are used to determine the color similarity in the centroid-linkage region growing stage 500.

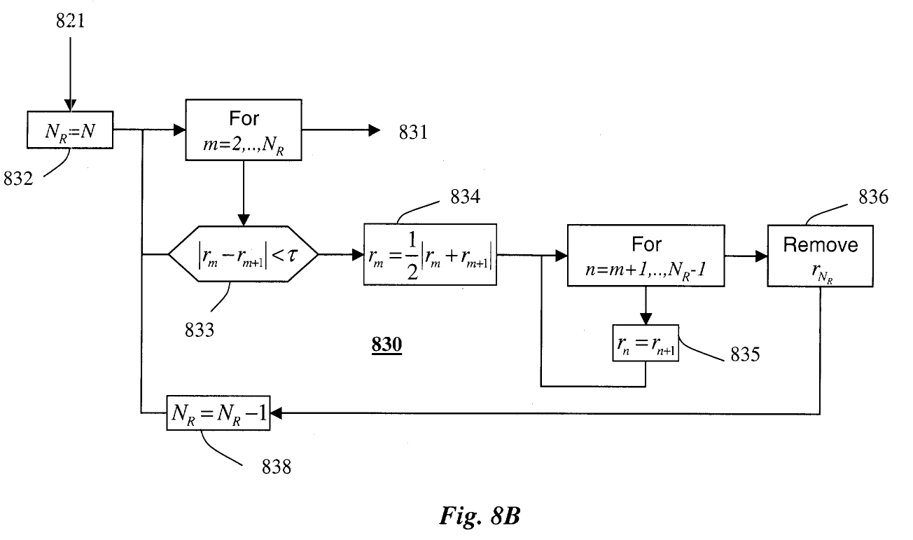

FIG. 7 shows color vector clustering 700 in greater detail. First, the input image 400 is scanned 701 to represent the color values of each pixel in a vector form. This can be done using a subset 703 of the input image, i.e., a down-sampled version of full resolution image. Initially, all the vectors are assumed to be in the same single cluster. A sum of color vector values is computed 710 for a color channel. A mean value vector w is obtained 715 by dividing the sum value of the number of pixels as

$$w = [ \begin{matrix}{w}_{R} \\ {w}_{G} \\ {w}_{B}\end{matrix} ] = [ \begin{matrix}\frac{1}{P} {\sum }_{p ∈ I} {I}_{R} ( p ) \\ \frac{1}{P} {\sum }_{p ∈ I} {I}_{G} ( p ) \\ \frac{1}{P} {\sum }_{p ∈ I} {I}_{B} ( p )\end{matrix} ] ,$$

where P is the total number of pixels in the image, I(p)=[I_{R}(p), I_{R}(p), I_{R}(p)] color value of a pixel p. The cluster center is a vector w=[w_{R}, w_{B}, w_{G}] where each element in the vector is the mean color value for the corresponding color channel of the cluster. Here, the notation assumes the RGB color space is used. Any other color space can be used as well.

Two vectors are obtained 730 from the mean value vector 715 by perturbing 720 the mean value vector values with a small value δ

$${w}^{-} = [ \begin{matrix}{w}_{R} - δ \\ {w}_{G} - δ \\ {w}_{B} - δ\end{matrix} ] , {w}^{+} = [ \begin{matrix}{w}_{R} + δ \\ {w}_{G} + δ \\ {w}_{B} + δ\end{matrix} ] .$$

Two cluster centers w⁻ and w⁺ that are different from each are initialized 730 either randomly or by other means. An initial distortion score D(0) 731 is set to zero. For each color vector I(p), measure a distance from the color vector to each center and group 740 each vector to the closest center. The cluster centers are then recalculated 745 with the new grouping. Next, the distortion score D(i) that measures the total distance within the same cluster is determined 750. If a difference 755 between the current and previous distortion scores is greater than the distortion threshold T, then regroup and recalculate the cluster centers 760.

Otherwise, if the number of clusters is less than a maximum K 770, then divide 755 each cluster into two new clusters by perturbing the cluster center by a small value, and proceed with the grouping step 780, otherwise done.

Channel Projection

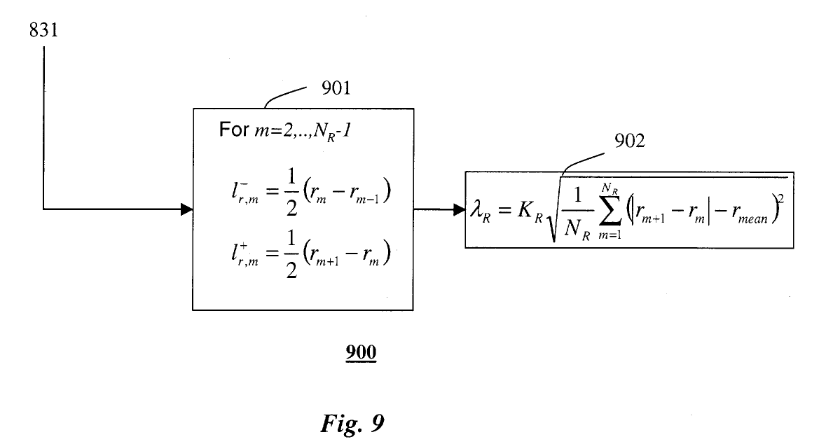

FIG. 8A shows the channel projection 800 in greater detail. From clustering, the cluster centers 790 are obtained. The cluster centers are regrouped 810 into sets 811 corresponding to the color channels. There are three sets, e.g., one for each of the RGB color values. Then, the elements of each set are ordered 820, from small to large, into a list 821, with respect to the magnitude of its elements. Any elements of the ordered list 821 are merged 830 if a distance between the elements is very small, i.e., less than an upper bound threshold τ as

$$\vert {r}_{k} - {r}_{k + 1} \vert < τ ⇒ {r}_{k} = \frac{1}{2} ( {r}_{k} + {r}_{k + 1} ) ,$$

where rₖ represents k^{th} element of the ordered list for a color channel. Here, the red channel is used for notation without losing the generality.

FIG. 8B shows the merging 800 in greater detail. Merging is performed separately on the N elements of each list, i.e., each channel. Two consecutive elements rₖ and rₖ₊₁ of the list are selected 832, and a distance between the two elements is computed 833. If the distance is less than the upper bound threshold τ, then an average value is computed, and the current element rₖ is replaced 834 by a single computed average value. The list elements that have larger index values than the element rₖ₊₁ are shifted left 835. The last element of the list is deleted 836. This replacement decreases 838 the number of elements in the list. Because the merging operation decreases the number of elements in the corresponding list, the total number of elements N_{R}, after the merging stage, can be less than the initial size of the list N.

Inter-Maxima Distances

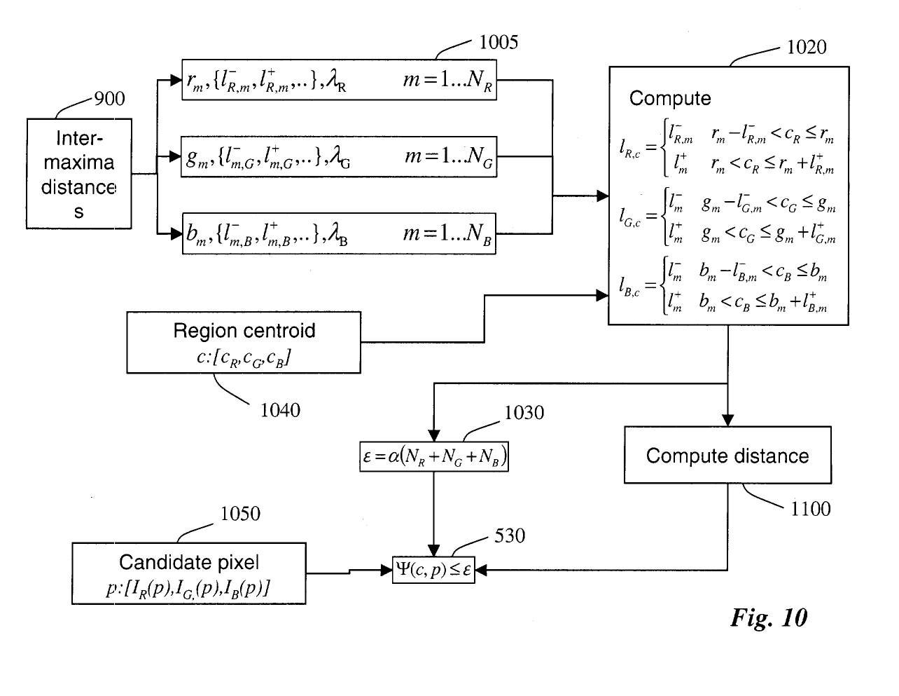

FIG. 9 shows how the inter-maxima distances l⁻ and ⁺ are determined. The inter-maxima distances between the ordered elements of the color values 831 are determined separately for each channel.

After merging 800, two distances 901 are determined from the cluster centers according to

$${l}_{m , R}^{-} = \frac{1}{2} ( {r}_{m} - {r}_{m - 1} )$$

$${l}_{m , R}^{+} = \frac{1}{2} ( {r}_{m + 1} - {r}_{m} )$$

for each color channel, e.g. for the red color channel in the above formulation. These distances represent the middle between the current maximum lₘ from the nearest smaller lₘ₋₁ and bigger lₘ₊₁ maximum in the list.

A standard deviation based score is also computed 902 according to

$${λ}_{R} = {K}_{R} \sqrt{\frac{1}{{N}_{R}} {\sum }_{m = 1}^{{N}_{R}} {( \vert {r}_{m + 1} - {r}_{m} \vert - {r}_{mean} )}^{2}} ,$$

where rₘₑₐₙ is the mean of the inter-maxima distances

$${r}_{mean} = \frac{1}{{N}_{R}} {\sum }_{m = 1}^{{N}_{R}} {l}_{m , R}^{+}$$

for each of the corresponding color channels. The mean rₘₑₐₙ can be computed from l⁻ as well. A constant K_{R} is a multiplier for normalization. In case K_{R}=2.5, the λ_{R} represents 95% of all the distances.

Color Distance Function

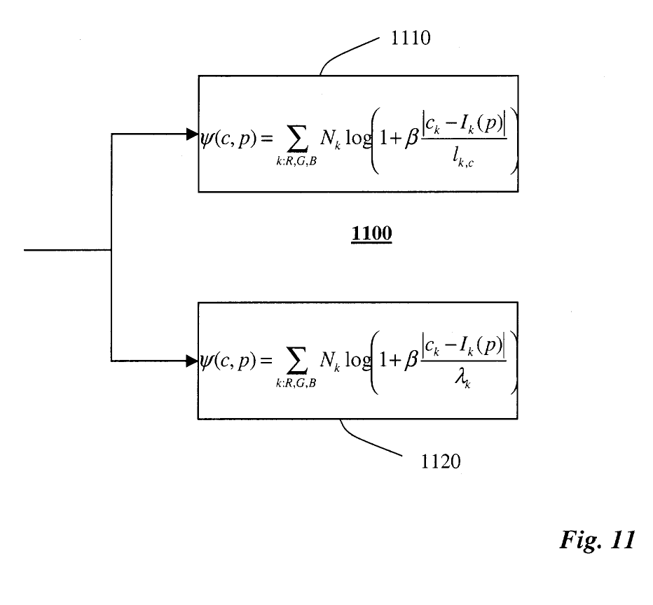

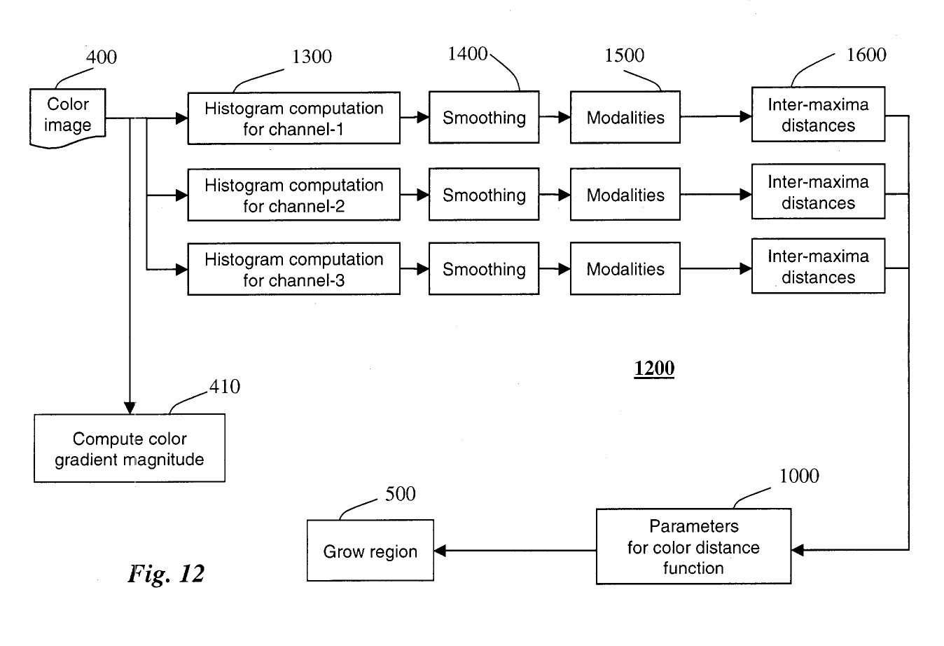

FIGS. 10 and 11 show the details of the color distance function formulation 1100. A region feature vector 1040, and a candidate pixel 1050 are supplied by the region-growing method 500, see FIGS. 5 and 10. A color distance 1110 or 1120 is determined for the candidate pixel and the current region.

The threshold ε and the distance Ψ are obtained, via steps 1005 and 1020 from the inter-maxima distances 900. Lambda (λₖ), where k:RGB, represent a standard deviation value based on the inter-maxima distances. The values N_{R}, N_{G}, N_{B} are the number of elements in the corresponding lists after merging.

The logarithm-based distance function uses a term 1120 to make the color evaluation more sensitive to small color differences by scaling non-linearly very high differences in a single channel. The distance parameter l_{k,c}, where k:RGB, is selected 1020 according to

$${l}_{R , c} = \{ \begin{matrix}{l}_{R , m}^{-} & {r}_{m} - {l}_{R , m}^{-} < {c}_{R} \leq {r}_{m} \\ {l}_{m}^{+} & {r}_{m} < {c}_{R} \leq {r}_{m} + {l}_{R , m}^{+}\end{matrix} \\ {l}_{G , c} = \{ \begin{matrix}{l}_{m}^{-} & {g}_{m} - {l}_{G , m}^{-} < {c}_{G} \leq {g}_{m} \\ {l}_{m}^{+} & {g}_{m} < {c}_{G} \leq {g}_{m} + {l}_{G , m}^{+}\end{matrix} \\ {l}_{B , c} = \{ \begin{matrix}{l}_{m}^{-} & {b}_{m} - {l}_{B , m}^{-} < {c}_{B} \leq {b}_{m} \\ {l}_{m}^{+} & {b}_{m} < {c}_{B} \leq {b}_{m} + {l}_{B , m}^{+}\end{matrix} ,$$

see above. This evaluation returns higher distance values when all the channels have moderate distances. If only one channel has a high difference and the other channels have insignificant difference, then a lower value is returned.

The weighting by the Nₖ's gives color channels a higher contribution when they have more distinguishable properties, i.e., there is more separate color information in the channel. The distance value is also scaled with the width of the 1-D cluster lₖ into which the current pixels color value falls. This enables equal normalization of the distance term with respect to each 1-D cluster.

The logarithm term is selected because it is sensitive towards small color differences while it prevents an erroneous distance for relatively large color difference in a single channel. Similar to a robust estimator, the logarithm term does not amplify color distance linearly or exponentially. In contrast, when the magnitude of the distance is small, the distance function increases moderately but then it remains the same for extremely deviant distances. Channel distances are weighted considering a channel that has more distinctive colors provides more information for segmentation.

The total number of dominant colors in a channel is multiplied with the distance term to increase the contribution of a channel that supplies more details, i.e., multiple dominant colors for segmentation. The distance threshold is assigned as

ε=α(N_{R}+N_{G}+N_{B}),

in case the distance is computed by 1110. In case equation 1120 is used, the threshold is assigned as

ε=α(λ_{R}+λ_{G}+λ_{B}).

The scaler α serves as a sensitivity parameter.

Adaptive Parameter Assignment with Histograms Modalities

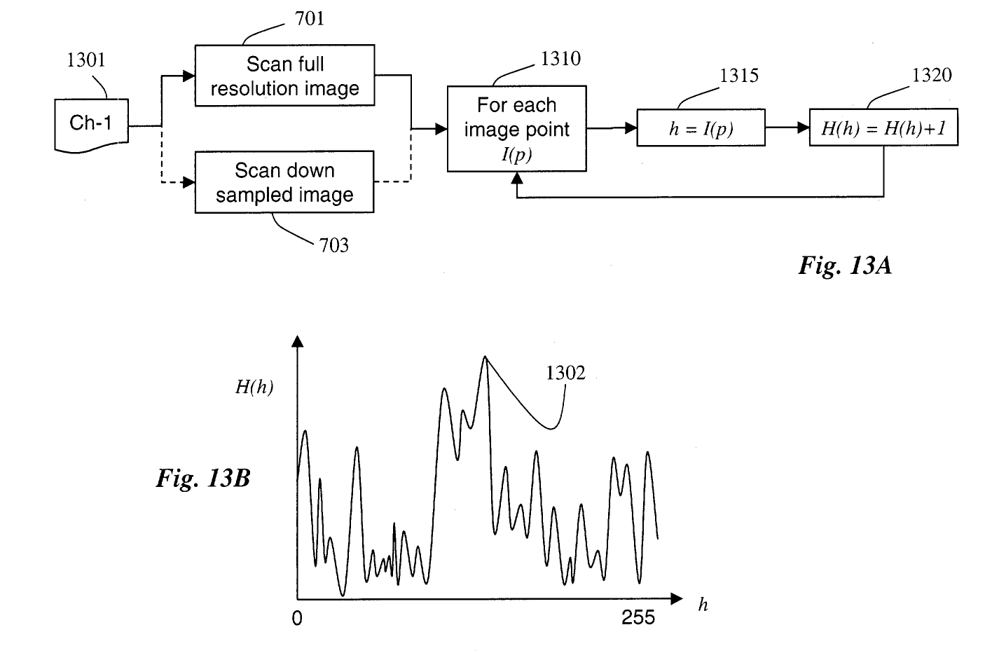

FIG. 12 shows the adaptive region using separate color channel histogram maxima. Starting again with the image or video 400. For each channel, a color histogram 1302 is computed 1300. The histograms are smoothed 1400, and their modalities are found 1500. The inter-maxima distances are determined 900 from the histogram modalities. The regions growing 500 is as described above.

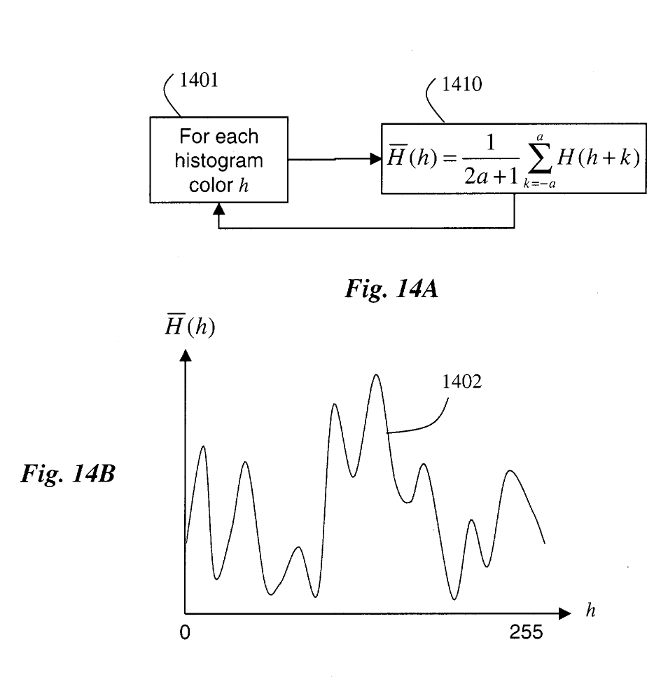

FIGS. 13A and 13B show how to construct a histogram 1302 from a channel 1301 of a full resolution input image 701, or from a sub-sampled version 702 of the input image 400. A histogram 1302 has color values h along the x-axis, and number of pixel H(h) 1315 for each color value along the y-axis. For each image pixel 1310, determine its color h 1315, and increment the number 1320 in the corresponding color bin according to

H(I(p))=H(I(p))+1 for ∀p.

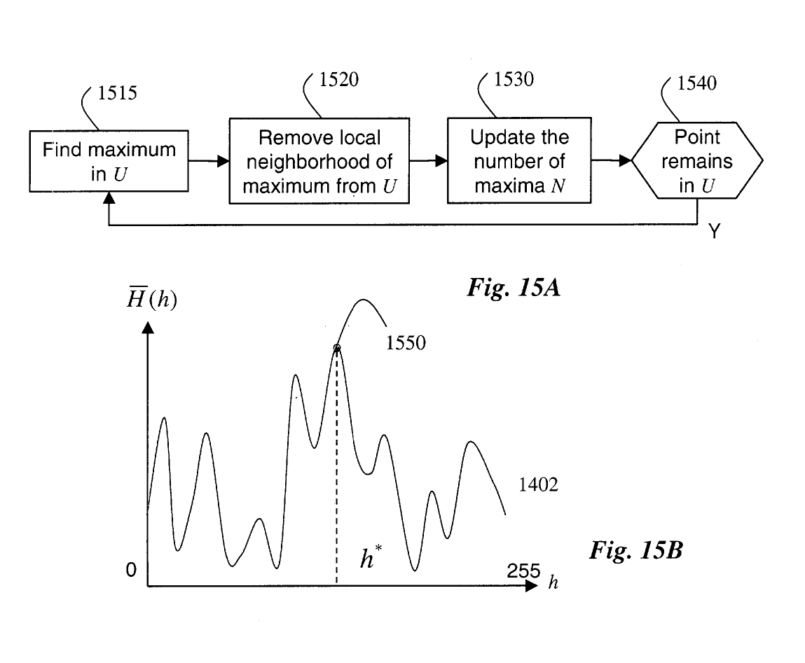

FIGS. 14A and 14B shows how an input histogram 1302 is averaged 1410 within a window [−a, a] to provide a smoothed histogram 1402 according to

$$\overline{H} ( h ) = \frac{1}{2 a + 1} {\sum }_{k = - a}^{a} H ( h + k ) .$$

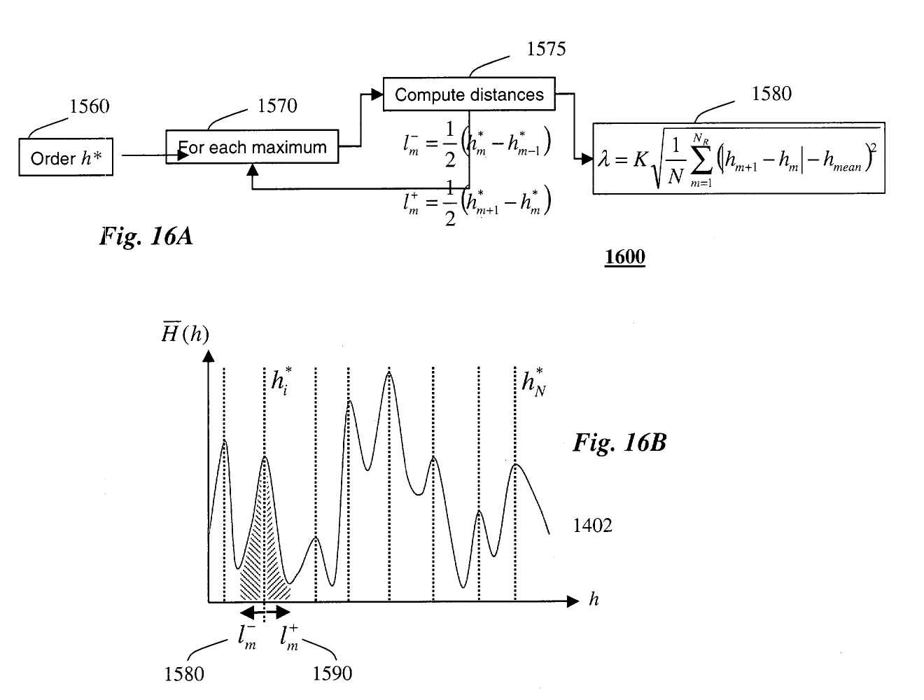

FIGS. 15A and 15B show how histogram modalities 1550 are found. A set U is a possible range of color values, i.e., [0,255] for an eight-bit color channel. To find 1515 the a local maximum in the set U for the histogram 1420, find the global maximum in the remaining set U, and increase the number of maxima by one. Remove 1520 the close values from the set U within a window [−b, b] around the current maximum, and update 1530 the number of maxima. Repeat 1540 until no point remains in the set U. This operation is performed for each color channel.

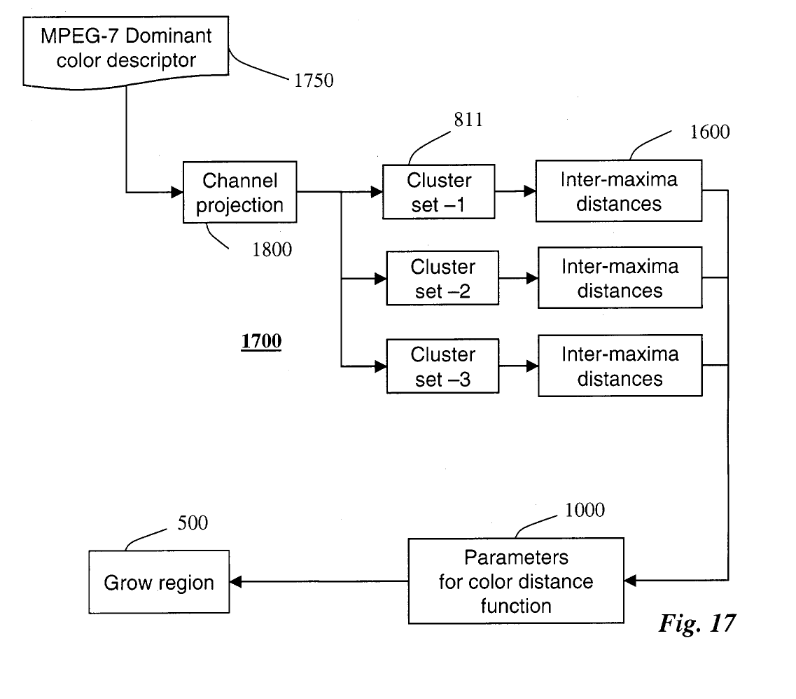

FIGS. 16A and 16B show how to compute the inter-maxima distances 1580, 1590. For each local maximum two distances between the previous and next maximums are computed 1575. The local maxima h* are processed in order 1560, and for each maximum 1570, the distance l⁻ and l⁺ are computed 1575

$${l}_{m}^{-} = \frac{1}{2} ( {h}_{m}^{*} - {h}_{m - 1}^{*} )$$

$${l}_{m}^{+} = \frac{1}{2} ( {h}_{m + 1}^{*} - {h}_{m}^{*} ) ,$$

and a standard deviation based score is obtained according to

$$λ = K \sqrt{\frac{1}{N} {\sum }_{m = 1}^{{N}_{R}} {( \vert {h}_{m + 1} - {h}_{m} \vert - {h}_{mean} )}^{2}}$$

where hₘₑₐₙ is the mean of the distances

$${h}_{mean} = \frac{1}{N} {\sum }_{m = 1}^{N} {l}_{m}^{+} .$$

These distances essentially correspond to a width of the peak around the local maximum. Using the above distances, the inter-maxima distances are obtained. This is similar to the process described for FIG. 9 with histogram value h replacing color values c. From the color image 501, for each channel 1301, the total number of maxima (N) 1701 are summed 1330 to determine epsilon ε 1030, and proceed as described before.

Adaptive Parameter Assignment with MPEG-7 Dominant Color Descriptors

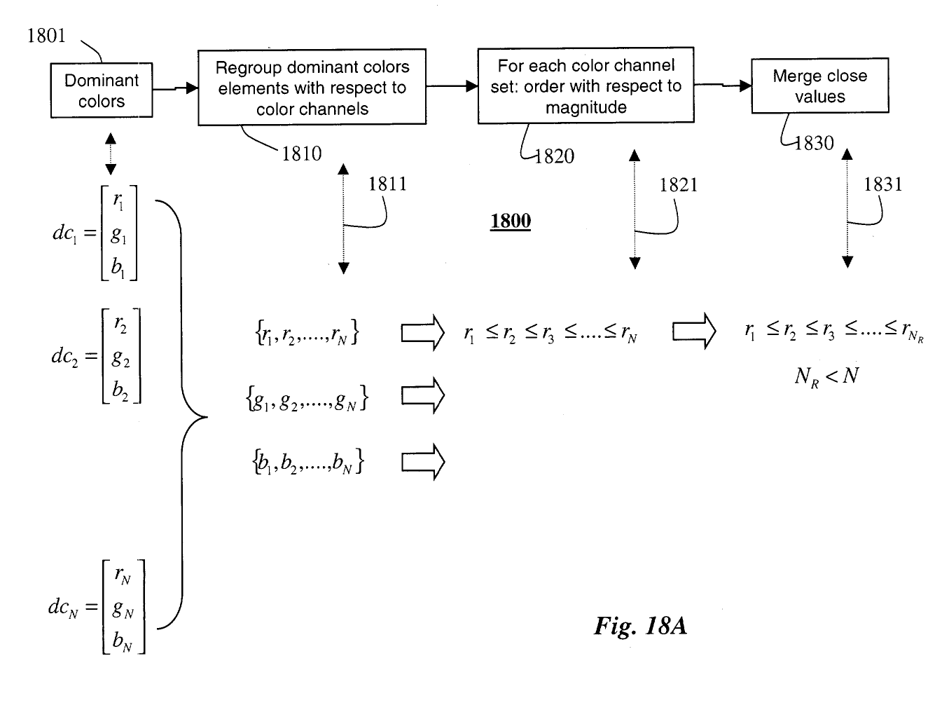

FIG. 17 shows the adaptive region growing method using the MPEG-7 dominant color descriptor. Note again the similarity with FIGS. 6 and 12. This figure shows how color distance threshold 1030 and color distance function parameters 1000 are determined from a color image using the MPEG-7 dominant color descriptor. As stated above, a set of dominant colors in a region of interest of an image provides a compact description of the image that is easy to index and retrieve. Dominant color descriptor depicts part or all of an image using a small number of colors.

Here, it is assumed that a MPEG descriptor 1750 is available for the image, or a part of the image for which color distance are required. A channel projection 800 is followed by computation of inter-dominant color distances 1600, for each channel 811. These distances for each channel are used to determine the parameters 1000 of color distance function and its threshold 1030. Also shown is the centroid-linkage region growing process 500. MPEG-7 supports dominant color descriptor that specifies the number, value, and variances of the most visible colors of an image.

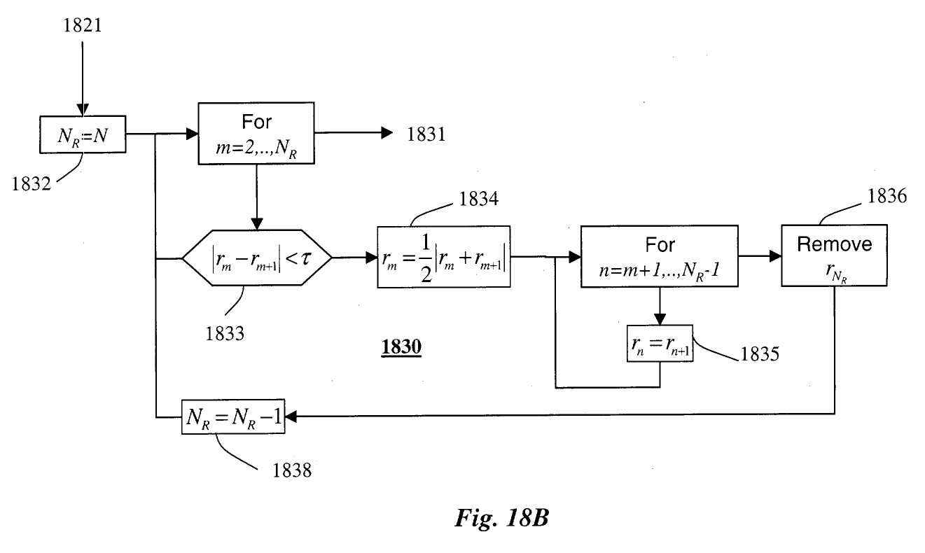

FIGS. 18A and 18B show the channel projection 1800 in greater detail in a similar manner as shown in FIG. 8. Corresponding elements of the dominant colors 1801 are put in the same set 1810, and reordered with respect to magnitude 1820. Close values are merged 1830. The inter-dominant color distances 1600 are determined as described for FIG. 9, and the color distance threshold and color distance function is performed as shown in FIGS. 10 and 11.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

I claim:

1. A method for segmenting pixels in an image, comprising:
extracting global features from the image;
selecting a set of seed pixels in the image;
defining local features for the set of seed pixels;
determining parameters and thresholds of a distance function from the global and local features;
growing a region around the seed pixels according to the distance function;
segmenting the region from the image; and
repeating the selecting, defining, growing and segmenting until no pixels remain.

2. The method of claim 2 wherein the global and local features are color values of the pixels.

3. The method of claim 1 wherein the growing is by centroid-linkage.

4. The method of claim 2 wherein the distance function is based on the color values.

5. The method of claim 1 wherein the thresholds determine a homogeneity of the region.

6. The method of claim 1 further comprising:
measuring color gradient magnitudes for the pixels; and
selecting pixels with minimum gradient magnitudes for the set of seed pixels.

7. The method of claim 1 wherein the local features are determined by color vector clustering.

8. The method of claim 1 wherein the local features are determined by color vector clustering.

9. The method of claim 1 wherein the local features are determined by histogram modalities.

10. The method of claim 1 wherein the local features are determined by MPEG-7 dominant color descriptors.

11. The method of claim 1 wherein the set of seed pixels includes a single pixel.

12. The method of claim 6 wherein the color gradient magnitudes are measured for spatially opposite neighboring pixels.

13. The method of claim 1 further comprising:
clustering color vectors of the image to determine the parameters of the distance function.

14. The method of claim 13 further comprising:
constructing a color histogram from the color vectors to determine the parameters of the distance function.

15. The method of claim 1 further comprising:
representing the color values by dominant color descriptors and determining the parameters of the distance function from the dominant color descriptors.

16. The method of claim 1 further comprising:
computing a color gradient magnitude for each pixel;
selecting the set of seed pixels according to a smallest color gradient magnitude;
initializing a region centroid vector according color values of the set of seed pixels.

17. The method of claim 1 further comprising:
constructing a color histogram for each color channel of the image;
smoothing the color histograms by a moving average filter in a local window;
finding local maxima of the color histogram;
removing a local neighborhood around each local maximum;
obtaining a total number of local maxima;
computing inter-maxima distances between a current maximum and an immediate following and previous maxima;
determining parameters of the distance function according to the inter-maxima distances;
determining an upper bound threshold function for the distance function.

18. The method of claim 1 further comprising:
obtaining MPEG-7 dominant color descriptors for a part of the image including the set of seed pixels;
grouping the MPEG-7 dominant color descriptors into channel sets having magnitudes;
ordering the channel set with respect to the magnitudes;
merging channel sets according to pair-wise distances;
determining a total number of channel sets;
computing inter-maxima distances from the ordered, merged channel sets; and
determining the parameters of the distance function according to the inter-maxima distances;
determining an upper bound threshold function for the distance function.
